(19) United States
(12) Patent Application Publication
(10) Pub. No.: US 2022/0192171 A1
(43) Pub. Date: Jun. 23, 2022

(54) PEST CONTROL SYSTEM AND METHOD FOR USE THEREOF

(71) Applicant: OTS INVESTCO INC. (Ontario Corporation No 00243119), Markham, CA (US)

(72) Inventor: Kirk OTS, Markham (CA)

(21) Appl. No.: 17/644,905

(22) Filed: Dec. 17, 2021

Related U.S. Application Data
(60) Provisional application No. 63/127,123, filed on Dec. 17, 2020.

(51) Int. Cl. A01M 1/02; A01M 1/20; A01M 25/00

(52) U.S. Cl. CPC A01M 1/026; A01M 25/004; A01M 1/2005

(57) ABSTRACT

In an aspect, a pest control system is provided, and includes at least one monitoring device and a control system. The at least one monitoring devices includes sensing circuitry, communication circuitry and a plurality of possible states which correspond to a plurality of actions of a target species. The sensing circuitry detects states from the plurality of possible states and the communication circuitry transmits at least one dataset relating to the detected states. The control system includes at least one processor and at least one memory, where the memory stores the at least one dataset transmitted from the at least one monitoring device as a stored dataset and the memory has instructions stored therein which are executable by the at least one processor for identifying a change in the actions of the target species of pest based on the at least one stored dataset.

### CROSS-REFERENCE TO RELATED APPLICATIONS

This application claims the benefit of U.S. Provisional Patent Application No. 63/127,123, filed Dec. 17, 2020.

### FIELD

This disclosure relates generally to a pest control system and more particularly to pest monitoring devices wirelessly connected to a device control system.

### BACKGROUND OF THE DISCLOSURE

It is well-known to provide pest traps with bait both within and outside of homes, apartment towers and industrial buildings for capturing and controlling pests, such as ants and other insects, and also other larger pests such as mice and other rodents.

The use of typical pest traps can be described as follows. Some form of bait or other means for attracting a target species of pest to the trap is loaded into the trap, which is then placed in a location where activity of the target species has been observed or would be expected. For example, in a residential home setting, the trap could be placed in areas behind stoves and fridges. In commercial and industrial settings, traps can be placed along walls in warehouses and processing environments and behind furniture and in corners of offices.

The contents of the traps are typically inspected at times that are convenient to a consumer or are scheduled by a pest control professional as part of a maintenance visit. Observations are made as to whether the bait has been consumed and how much bait has been consumed. Conclusions on strategies for controlling the target species of pest are typically made based on these observations. This is a relatively inaccurate method by which strategies for controlling pests can be devised. Between the times the monitoring devices are deployed and the times they are inspected, there is no data available to the homeowner or pest control professional as to whether the devices are proving effective in controlling the population of the target species.

It would therefore be advantageous to be able to provide a pest control system that at least partially resolves the above noted issues by providing more detailed information about the actions of pests of a target species and/or predictions as to the future actions of the pests.

The proposed pest monitoring devices of the pest control system, whether for mice, rats, insects or some other species, are made of at least a bottom container that has an entry aperture at one end and an area for loading the bait. The bait once ingested, may kill the pest. The devices may detect pest activity and actions and communicate data of the pests actions to a person managing the devices, whether it is a consumer or a pest control professional.

### SUMMARY OF THE DISCLOSURE

A further understanding of the functional and advantageous aspects of the disclosure can be realized by reference to the following detailed description and drawings.

In an aspect, a pest control system is provided for monitoring a target species of pest and includes at least one monitoring device having a plurality of possible states which represent a plurality of actions of the target species of pest, the plurality of actions relating to at least one alterable aspect of the at least one monitoring device. The at least one monitoring device includes sensing circuitry positioned to detect states from the plurality of possible states, and communication circuitry operable to transmit at least one dataset relating to the detections of the states over a wireless communication network. The pest control system includes a control system including at least one processor and at least one memory. The control system is configured to receive and to store the at least one dataset in the at least one memory so as to generate at least one stored dataset. The at least one memory has stored therein instructions executable by the at least one processor for identifying a change in the actions of the target species of pest based on the at least one stored dataset and providing a notification through an interface of the control system, that is indicative of the change in the actions of the target species of pest.

In an aspect, a method of monitoring a target species of pests is provided which comprises the steps of: providing at least one monitoring device having a plurality of possible states, which represent a plurality of actions of the target species of pest, the plurality of actions relating to at least one alterable aspect of the at least one monitoring device, detecting states from the plurality of possible states on each of the at least one monitoring device, transmitting at least one dataset of the detections of the states to a control system, using the control system to identify a change in the actions of the target species of pest based on the at least one stored dataset, and providing a notification through an interface of the control system, that is indicative of the change in the actions of the target species of pest.

Other technical advantages may become readily apparent to one of ordinary skill in the art after review of the following figures and description.

### BRIEF DESCRIPTIONS OF THE DRAWINGS

For a better understanding of the embodiment(s) described herein and to show more clearly how the embodiment(s) may be carried into effect, reference will now be made, by way of example only, to the accompanying drawings in which:

Embodiments will now be described, by way of example only, with reference to the drawings, in which:

FIG. 1 shows a schematic of the primary elements of the pest control system;

FIG. 2 shows a flow-chart diagram for a method of use of the proposed pest control system

FIG. 3 shows an isometric view of an embodiment of the pest monitoring device;

FIG. 4 shows a schematic of the circuitry for an embodiment of the pest monitoring device;

FIG. 5A shows a blown-apart view of an embodiment of the pest monitoring device with a removable module;

FIG. 5B shows an isometric view of an embodiment of the pest monitoring device with a removable module;

FIG. 6 shows a schematic of the elements of the pest monitoring and controlling system where the control system includes a computing device, and where the elements are connected to a local wireless network;

FIG. 7A shows an embodiment of an application displayed on an interface of a computing device of the control system;

FIG. 7B shows an alternative embodiment of an application displayed on the interface of the computing device of the control system;

FIG. 7C shows another alternative embodiment of an application displayed on the interface of the computing device of the control system.

Unless otherwise specifically noted, articles depicted in the drawings are not necessarily drawn to scale.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

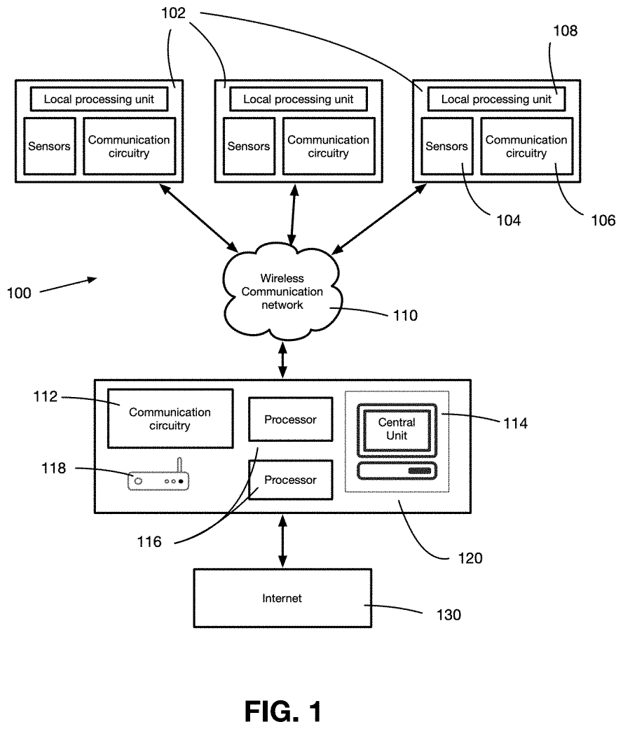

Reference is made to FIG. 1, which shows a schematic of an embodiment of the pest control system. In the embodiment shown, at least one monitoring device 102 is provided, the device containing a portion of bait that is attractive to a target species of pest. The target species may be any pest suitable for detection in the system including rodents (mice and rats), termites, ants or cockroaches. In an embodiment, the bait which is ingested by the target species of pest is poisonous to the target species. In an alternative embodiment the bait is not poisonous to the target species. The at least one monitoring device 102 is connected via a wireless communication network 110 to a control system 120. The control system 120 is configured to analyze at least one dataset captured by the at least one monitoring device to identify a change in the actions of a target species of pest, where the change is in response to an alterable aspect of at least one of the monitoring devices. In an embodiment, multiple monitoring devices may be placed throughout a monitoring environment for detecting and analyzing the actions of the target species of pests throughout a target area of the monitoring environment.

The at least one monitoring device 102 has a plurality of possible states which represent a plurality of actions of the target species of pest. The monitoring device also includes sensing circuitry 104 positioned to detect states from the plurality of states of the monitoring device. The sensing circuitry includes at least one sensor. The at least one monitoring device 102 also includes communication circuitry 106 which is connected to the wireless communication network 110. The communication circuitry 106 is operable to transmit at least one dataset relating to the states of the plurality of possible states of the monitoring device 102 detected by the sensing circuitry 104 over the wireless communication network. The at least one dataset is received by the control system 120 for storage and analysis. A local processing unit 108 is provided within each of the at least one monitoring device 102 to control the activation and function of the sensing circuitry 104 and to control the transmission of datasets through the communication circuitry 106 between the at least one monitoring device 102 and the control system 120.

The control system 120 is generally configured to receive at least one dataset of the detected states from each of the at least one monitoring device 102. The control system 120 also includes communication circuitry 112 connected to the wireless communication network 110 and configured to receive at least one dataset transmitted from the at least one monitoring device 102. The control system also includes at least one processor and at least one associated memory 116 and may include multiple processors and associated memory. In an embodiment where the control system is spaced away from a monitoring environment where the device is being used, an intermediate device can be provided between the at least one monitoring device 102 and the control system 120 to relay at least one dataset transmitted from the monitoring device to the control system. In an additional embodiment, the intermediate device is a router installed in the monitoring environment. The router is configured to receive data transmitted from the devices over a network and is connected to the internet to communicate with a control system having a remote server, where the control system is spaced away from the monitoring environment.

The control system includes at least one processor and associated memory 116 which is connected to the communication circuitry of the control system 112 for receiving and storing datasets transmitted from the at least one monitoring device 102 so as to generate at least one stored dataset. The associated memory includes instructions that are executable by the processor for controlling the in-flow of the at least one dataset from the at least one monitoring device 102 via the communication circuitry 112 and for controlling the transmission of signals or datasets to the at least one monitoring device 102 from the control system 120. If multiple datasets are received from the at least one monitoring device 102 they may be stored in the memory of the control system as one or more stored datasets. The memory associated with processors of the control system also store instructions executable by the at least one processor for analyzing the at least one stored dataset transmitted from the at least one monitoring device 102 to identify a change in the actions of the target species of pest in response to an alterable aspect of the at least one monitoring device.

In an embodiment, based on an analysis of the stored datasets by the processors 116, if a change in an action of the target species relating to an alterable aspect of the at least one monitoring device 102 is identified, a notification is provided through an interface of the control system 120 that is indicative of the change in the actions of the target species of pest. In an embodiment, this notification indicates that the alterable aspect of the at least one monitoring device 102 should be changed.

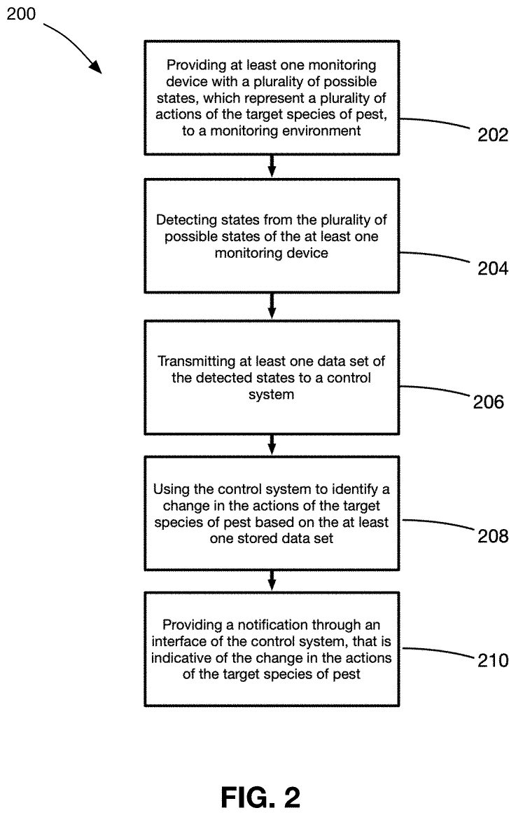

Referring to FIG. 2, a method of using the pest control system presented to control a target species of pests is provided. The method 200 comprises the steps of providing, within a monitoring environment, at least one monitoring device that has a plurality of possible states which represent a plurality of actions of a target species of pest 202, where the plurality of actions relate to at least one alterable aspect of the at least one monitoring device and detecting states from the plurality of possible states on each of the at least one monitoring device. The method further includes the steps of transmitting at least one dataset of the detections of the states from the at least one monitoring device 206, using the control system to identify a change in the actions of the target species of pest based on the at least one stored dataset 208 and providing a notification through an interface of the control system 210, where the notification is indicative of the change in the actions of the target species of pest.

In an embodiment of the method, the step of transmitting the at least one dataset further includes the step of storing the at least one transmitted dataset from the monitoring device on a memory of the control system to generate at least one stored dataset, and analyzing the at least one stored dataset collected over a period of time to identify a change in the actions of the target species in response to at least one alterable aspect of the at least one monitoring device.

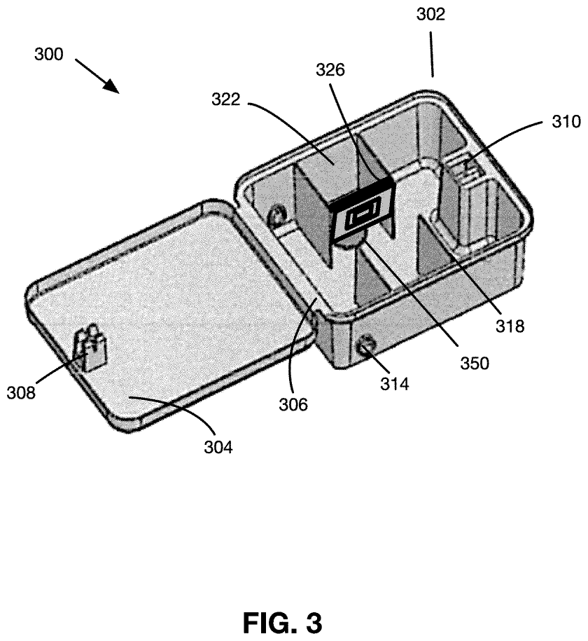

Referring now to FIG. 3, an embodiment of a monitoring device utilized by the proposed system is shown. The monitoring devices is generally comprised of a container unit configured to rest on a surface and hold the sensing circuitry included in the monitoring device for sensing a plurality of possible states of the monitoring device. In an embodiment, the monitoring device also holds a portion of bait to be consumed by the target species.

One or more possible states of the at least one monitoring device that are sensed by at least one sensor of the sensing circuitry can be used to provide information that is indicative of at least one target species action within, on or around the at least one device. In an embodiment, two of the plurality of possible states sensed by the sensing circuitry are the presence or absence of pest of the target species in an interior, bait storage section of the container unit of the device.

In another embodiment, the at least one monitoring device may include additional sensing circuitry that can detect a location of the device in relation to other devices, the position of the device in relation to the control system or a global, co-ordinate-based location of the device. The detected location of the at least one device can be transmitted to the control system as an additional dataset and may be stored in the control system as part of the at least one stored dataset or as a separate stored dataset.

The container unit of the device generally has some form of bait storage section access member such as a lid, through which a user can access an interior section of the container unit. In an embodiment, the container unit and access member are preferably made of a rigid, durable plastic such as ABS. The container unit is formed and has sufficient size to house the sensing circuitry, the communication circuitry and one or more channels, chambers or the like which are large enough to hold at least one individual pest of the target species.

In the embodiment of a monitoring device provided in FIG. 3, the container unit 302 has a rectangular form and has an opening on a top side. A lid 304 is movably connected to the container unit via a hinged mechanism 306. The opening and closing of the lid allows a user to access the device interior to change or replenish the bait in the device, to remove target species that have become trapped in the device and to replace batteries which power the device circuitry. The lid includes a locking abutment 308 that is configured to be removably received by a locking attachment 310 within the container unit. The engagement of the abutment 308 and the attachment 310 secures the lid onto the container unit to prevent unintended access to the bait storage section 312 of the device (i.e. by a child or pet living in an environment where the device is being used). The container unit 302 comprises at least one entry aperture 314. The at least one entry aperture 314 allows a target species to access the interior of the container unit and is generally sized to allow an individual pest from the target species to enter through the aperture 314. The entry aperture 314 may be configured to have an adjustable size.

In the embodiment provided in FIG. 3, the interior of the container unit 302 includes a bait storage section 322 which holds a respective portion of bait to be ingested by an individual pest of the target species. The bait storage section 322 may include walled structures 318 that form a passageway or channel which guides the individual pest of the target species from the entry aperture 314 towards the bait within the bait storage section 322. In this embodiment, the bait storage section includes a detection sensor 326 and associated sensor control circuitry 328 that is positioned at an entrance to the bait storage section. The detection sensor 326 is configured to detect and produce a signal or data point in response to a pest entering or leaving the bait storage section 322. A first signal is produced when the sensor 326 detects a pest moving into the bait storage section 322 and a second signal that is produced after this first detection is assumed to be the pest leaving the bait storage section 322. In an embodiment, the pairing of these two signals enables the device to log a pest going in and out of the bait storage section 322. The detection sensor 326 in the bait storage section 322 is preferably a motion detection sensor such as one or more of the following detection sensors: an infrared temperature sensor, an infrared movement sensor, a mechanical tripping means and further bait for attracting the particular target species or an optical sensing means in the form of a digital camera technique, for example CIF, CCD, or VGA technology cooperating with suitable analysis and recognition software.

In an embodiment, there are multiple bait storage sections within the device, each holding a portion of a different type of bait to be ingested by the target species. Each bait storage section includes a respective sensor and associated control circuitry as part of the sensing circuitry which are located at respective entrances of each of the bait storage sections.

In an embodiment, the sensing circuitry of the at least one monitoring device includes additional sensors configured to detect a state of the plurality of possible states that is not a presence or absence of a target species. The monitoring device can include a position sensor housed within the bait storage section of the container unit. The bait is placed on top of this position sensor so that the sensor can detect the presence or absence of bait in the bait storage section which is indicative of the bait being consumed by a target species. In an additional embodiment, the at least one monitoring device includes a form of location sensor and associated circuitry. This location sensor may be housed within the container unit of the device or may be mounted on an exterior surface of the monitoring device. The sensor is configured to detect and produce signals or data to communicate either a global location of the device (absolute coordinates) or a relative location of the device in relation to the control system or to one or more additional monitoring devices being used in an environment.

As noted previously, the at least one monitoring device includes one or more alterable aspects of its structure or components which can be altered to affect the actions of a target species around or within the at least one monitoring device. These alterable aspects include, but are not limited to, a type of bait in the devices, an amount of a portion of bait provided within the device, a type of bait contained within the device, a position of bait within the device and a location or relative position of the devices within the monitoring environment.

In the embodiment of the monitoring device presented in FIG. 3, the container unit of the monitoring device also houses communication circuitry which connects the monitoring device 300 to the wireless communication network. The device is connected to the wireless communication network to transmit over the network at least one dataset of the detected states of the plurality of possible states collected by the sensing circuitry.

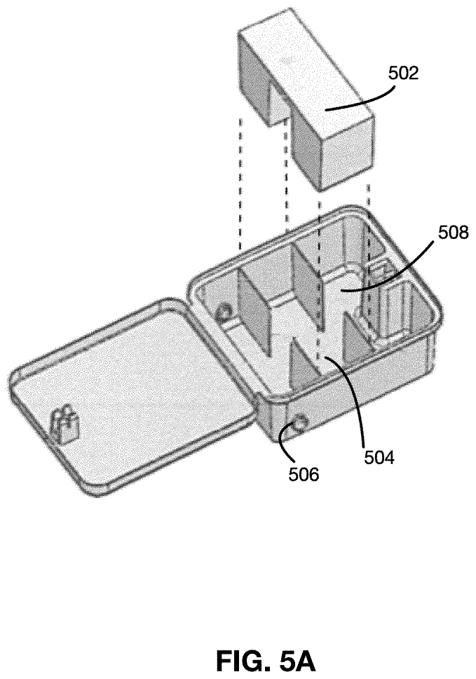

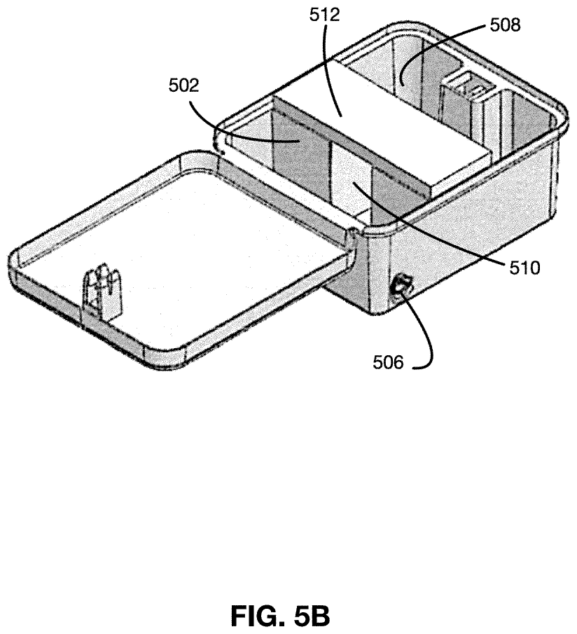

In an embodiment presented in FIGS. 5A and 5B, the sensing circuitry, communication circuitry and a local processing unit within the container unit of the at least one monitoring device 500 are housed in a removable sensor module 502. The removable module 502 is configured to be inserted and removed from a section 504 in the container unit 302 that is shaped to receive and retain the module 502. The section 504 of the container unit is generally spaced between an entry aperture 506 and a bait storage section 508 of the container unit. In an embodiment, the module is configured with a passageway or conduit 510 through which an individual pest of the target species passes to move from the entry aperture 506 of the container unit to the bait storage section 508. The passageway 510 is configured with a motion detection unit 512 such as a passive-infrared detector to detect a target species moving into and leaving the bait storage section 508. The motion detection unit 512 will send two signals to a processing unit of module 502, one when the pest of the target species passes through the conduit 510 a first time, and again when the pest leaves the bait storage section 508.

In an embodiment where the at least one monitoring device 500 is multiple monitoring devices with removable sensor modules 502, the removable modules 502 further comprise an RFID reader system. In this embodiment, each of the at least one monitoring device 500 includes a permanent RFID tag connected to either the exterior housing or the container unit of the monitoring device. The RFID reader of each module can wirelessly track and register which removable module is mounted in which monitoring device housing and can relay this information to the control system via the communication circuitry.

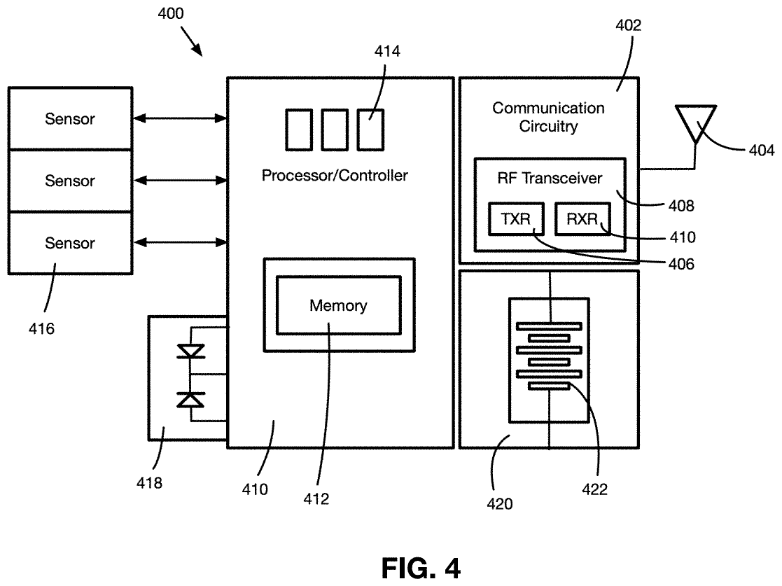

Referring now to FIG. 4, a schematic of the circuitry 400 within an exemplary device of the at least monitoring device is provided. The communication circuitry 402 includes a receiving element and a transmitting element and defines a wireless communication node within the wireless communication network. In the embodiment presented in FIG. 4, the communication circuitry, includes a communication antenna 404 and an RF transceiver 408 which is comprised of a transmitter 406 (TXR) and receiver 410 (RXR). At least a portion of the transmitter 406 and a portion of the receiver 410 may be included in a single, integrated unit of the circuitry 400. The transmitter 406 and receiver 410 can also be configured to perform transmission and reception functionality separately within the circuitry.

The communication circuitry 402 is connected to a local processing unit 420 housed within the at least one monitoring device and is connected to an electrical power source 430 in the form of one or more batteries 422. The local processing unit 420 housed within the at least one monitoring device is an electronic circuit comprised of one or more components including a memory 412. The local processing unit is also connected to the one or more sensors 416 which are part of the sensing circuitry. The local processing unit 420 controls the activity of each of the sensors of the sensing circuitry and will receive data captured from each of the sensors 416 to package before it is sent over through the communication circuitry 402. More than one processor sub-unit 414 may be included in the local processing unit 410. The circuit of the local processing unit 410 can be comprised of digital circuitry, analog circuitry or both and can be a hardwired state machine or a firmware programmable machine. The local processing unit memory 412 can be comprised of one or more components and can be a variety of types including volatile, nonvolatile, solid state, optical or magnetic, or a combination of any of these varieties. In an embodiment, the local processing unit 410 comprises a programmable microcontroller in a solid-state integrated circuit that integrally includes a processor and memory and is connected to the one or more sensors 416 and to the communication circuitry 402. In an embodiment, the at least one monitoring device also includes one or more indicator lights 418 (i.e. LEDs) which are connected to the local processing unit 410.

The data captured by the sensors 416 of the sensing circuitry can be packaged and transmitted to the control system in various ways. In an embodiment, the communication circuitry 402 is instructed by the local processing unit 410 to send at least one dataset of the detected states of the plurality of possible states to the control system every time one of the sensors 416 detects a change in at least one of the plurality of possible states.

In an alternative embodiment, the communication circuitry 402 is instructed by the local processing unit 410 to send at least one dataset of the detected state of the plurality of possible states along the wireless communication network to the control system at predetermined intervals of time. In this embodiment, the at least one sensor 416 of the sensing circuitry in the at least one monitoring device produces data in response to a difference in the plurality of possible states of the monitoring device. The local processing 410 unit has sufficient local memory 412 to store data associated with each instance of change in a detected state so as to form a local stored dataset. The local stored dataset will store all the datasets generated by the at least one sensor 416 of the sensing circuitry during a particular interval of time before the local dataset is transmitted along the wireless communication network to the control system.

In an embodiment, the at least one monitoring device is configured to only send at least one dataset along the wireless communication network when requested by the control system. The at least one sensor 416 produces data in response to a difference in at least one of a plurality of possible states. Again, the local processing 410 unit has sufficient memory 412 to store data associated with each instance of a detected difference in a state of the plurality of possible states so as to form a local stored dataset. The local stored dataset will store all the datasets sensed by the at least one sensor 416 of the sensing circuitry during a particular interval before the control system requests that the local dataset be sent along the wireless communication network.

In an embodiment, the local processing unit 410 of the at least one monitoring device comprises a processor and an associated memory with stored instructions and sufficient storage space and processing power to enable the local processing unit to analyze at least one local, stored dataset of the multiple, possible states of the device to identify a change in an action of the target species in response to at least one alterable aspect of the monitoring device and produce an analysis dataset. Based on this analysis, the communication circuitry 402 of the at least one device may send the local, stored dataset and/or the analysis dataset to the control system. The control system may be instructed to perform additional analysis on the local, stored dataset or the control system may use the analysis dataset as the basis to provide a set of information and a notification to the user through an interface of the control system. This notification may indicate that an alterable aspect of the at least one monitoring device should be changed. In an embodiment where the pest control system includes more than one monitoring device, some or all of the monitoring devices are capable of locally analyzing at least some aspects of the local, stored dataset acquired by the sensing circuitry of the device to produce an analysis dataset as described previously.

The link between the at least one monitoring device and the local communication server may be wired, however, the preferred embodiment uses some form of wireless communication network to link the at least one monitoring device to the control system. Among the specific technologies for wireless local communication, the wireless communication network may be any one of the following: a WLAN (i.e. an 802.11 standard) network, Bluetooth network, radio frequency network or other similar systems.

In an embodiment, the wireless communication network and associated network hardware is an independent network that already exists within the monitoring environment in which the at least one monitoring device is deployed. In an alternative embodiment, the hardware for generating the wireless communication network is integrated within the control system itself.

In an additional embodiment, circuitry is provided within one of the at least one monitoring device to create a web server locally within the monitoring device. In an embodiment, this circuitry is a Wi-Fi microchip with a full TCP/IP stack and an integrated microcontroller.

In an additional embodiment, the wireless communication network is an encrypted network which limits or prevents interference with other wireless systems in the environment where the at least one monitoring devices is deployed.

As noted previously, the control system 120 is configured to receive datasets of the plurality of possible states of each of the at least one monitoring device 102. The control system 120 includes communication circuitry 112 connected to the wireless communication network 110 and configured to receive the at least one dataset transmitted from the monitoring device 102 over the wireless communication network 110. In an embodiment, the control system includes multiple processors 116 and associated memory. The control system can have multiple control elements contained therewithin, where one of these control elements is a central control unit 114 with a processor and associated memory. The control system may also be configured to connect to the internet 130. In an embodiment, the control system 120 also includes suitable internal hardware 118 for generating the wireless communication network.

The at least one dataset may be received by the control system in a variety of configurations. The received at least one dataset may be just one dataset from one monitoring device of the detected plurality of possible states of that device. The dataset may also be a dataset of the detected plurality of possible states of a device received from each device in a network of multiple monitoring devices. The datasets may be multiple datasets received from each device within a network of multiple monitoring devices. In an embodiment, the control system is configured to receive a dataset from the at least one monitoring device every time one of the sensors of the at least one monitoring device detects a difference in a detectable state of the plurality of possible states of the at least one monitoring device. In an alternative embodiment, the communication circuitry of the control system is configured to receive at least one dataset along the wireless communication network at predetermined intervals of time.

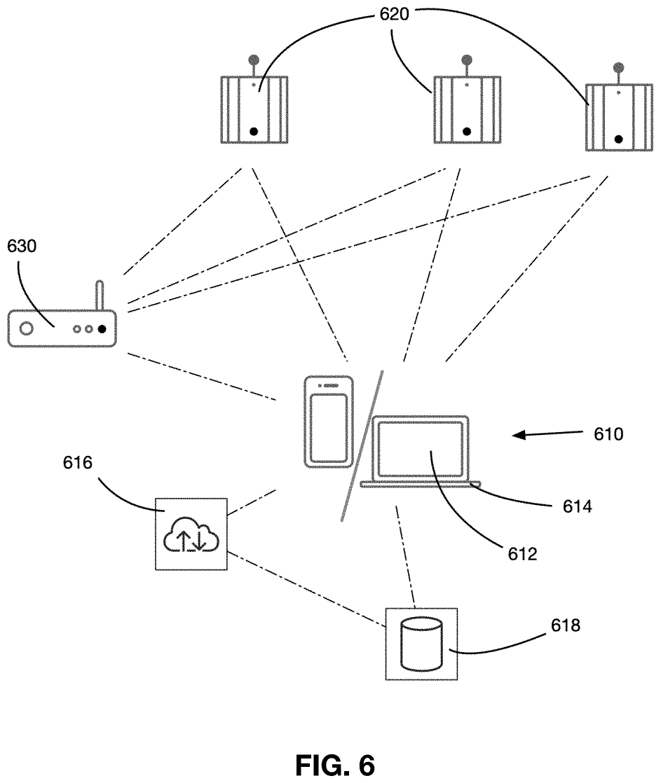

In an embodiment of the system 600 provided in FIG. 6, the central unit of the control system 610 is in the form of a personalized computing device such as a smartphone, laptop or tablet 612. In this embodiment, an interface of the control system 614 is the interface of the personalized computing device. The wireless communication network and associated network hardware is an independent network that already exists within the environment in which the at least one monitoring device 620 is deployed, specifically a local Wi-fi network. A modem and router 630 are already provided within a home or building, and the at least one monitoring device 620 and central unit of the control system 610 may be configured with appropriate communication hardware (i.e. a network interface controller) to connect to the network and transmit at least one datasets over the network. The control system can also use the local network to access the internet 616 and can access one or more local or network accessible databases 618.

The control system generally comprises memory for storing at least one dataset received from at least one monitoring device, the memory being configured to store the at least one received dataset as at least one stored dataset for further analysis. In an embodiment, the memory that stores the at least one stored dataset is the associated memory of the central control unit. In an embodiment where datasets are received from multiple monitoring devices, the memory within the central control unit includes one or more databases for storing the multiple datasets of the detected plurality of possible states captured by the multiple monitoring devices. The multiple datasets can include device registration information such as a device ID's or device location information and can also include data of the detected state of the plurality of possible states of the multiple monitoring devices.

The at least one processor and associated memory of the control system include instructions executable by the at least one of processor for analyzing the at least one stored dataset. In a preferred embodiment, the instructions are stored on the memory of the central control unit and executed by the processor of the central control unit. The at least one stored dataset is generally analyzed to identify a difference in the actions of the target species of pest in response to at least one alterable aspect of at least one monitoring device. As noted previously, the at least one stored dataset includes data of one or more possible states of at least one monitoring device that are detected by the sensing circuitry of the at least one device. The detectable states are used to interpret or estimate changes in the actions of the target species in and around the at least one monitoring device. For example, the presence and subsequent absence of a pest of the target species in a bait storage section of the device may be indicative of a pest of the target species entering and leaving the monitoring device. The data of the detected states of the plurality of possible states can be algorithmically analyzed to identify changes in the actions of the target species.

In an embodiment, a first state from the plurality of possible states of the at least one monitoring device which is detected by the sensing circuitry is a presence of an individual pest of the target species in the device. A second state from the plurality of possible states of the at least one monitoring device which is detected by the sensing circuitry is a lack of presence of any of the target species in the device.

In an additional embodiment, a first state from the plurality of states corresponds to a presence of a pest of the target species within the at least one monitoring device and the stored dataset shows a reduced number of detections of the first state, over time. The reduced number of detections over time may be indicative of the target species developing an aversion to the bait in the at least one monitoring device.

In an embodiment, a first state from the plurality of possible states of the at least one monitoring device is a presence of an individual pest of the target species at the pest control system. In this embodiment, the notification provided via the user interface indicates that the type of bait stored within the bait storage section of at least one of the at least one monitoring device should be replaced, based on how many detections of the first state have been made by the sensing circuitry.

The specifics of the data included in the at least one stored dataset influences the analysis which is performed to identify changes in actions of the target species. In an exemplary embodiment, the at least one stored dataset includes data of discrete sums or tallies of the number entries and exits of a target species into multiple monitoring devices, and includes data of the present location of each of the multiple monitoring devices in the environment where the devices are deployed. Algorithms can be applied to analyze the at least one stored dataset to identify improperly placed monitoring devices that the target species are not entering or are not using.

In an embodiment, the at least one stored dataset is a dataset that includes the number of entries of a target species into the bait storage section of a particular monitoring device over time. The at least one dataset can be analyzed by algorithms to identify a decrease in target species entries over time which may signal or predict the target species developing an aversion to the bait held within the particular monitoring device.

In an embodiment where the at least one monitoring devices has multiple bait storage sections each holding a different type of bait, the stored at least one dataset is a dataset that includes the number of individual entries of a target species into the multiple bait storage sections of the at least one device. The at least one dataset can be analyzed to identify a type of bait that is preferred by the target species.

In an additional embodiment, the at least one stored dataset includes the location of multiple monitoring devices and a count over time of the number of target species entries and exits from the bait storage section of each of the multiple monitoring devices. Algorithms can be applied to identify a difference in the actions of the target species of pest at a first one of the monitoring devices as compared to the actions of the target species of pest at a second one of the monitoring devices. The difference in actions of the target species between the devices identified in the data can be indicative of a difference in the consumption of the bait by the target species between the devices. In an additional embodiment, the identified difference in the consumption of bait by the target species between multiple monitoring devices is due to the target species developing an aversion to the bait in some of the multiple monitoring devices.

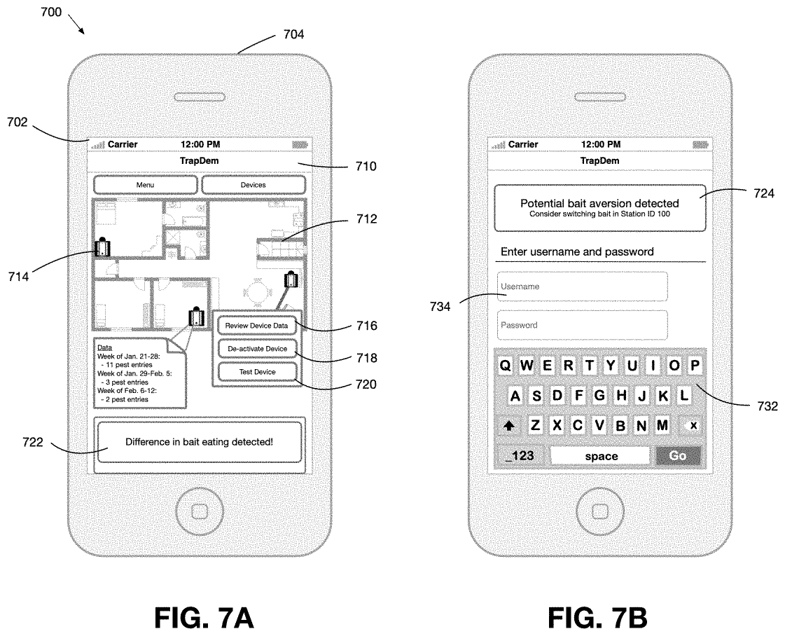

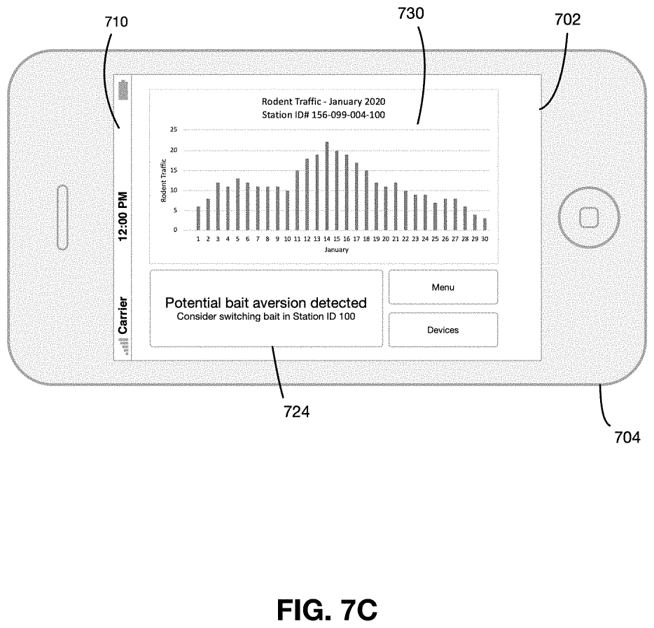

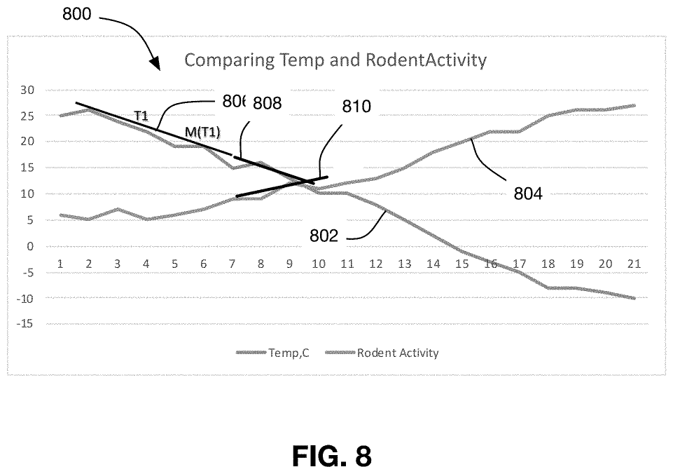

The central control unit includes a user interface through which information related to the at least one stored dataset is provided. In an embodiment presented in FIGS. 7A and 7B, the interface of the central control unit 700 of the control system includes a touchscreen interface 702 of a computing device 704 such as a smartphone or tablet. In the embodiment presented in FIG. 7A, an application 710 on the computing device 704 may be displayed on the interface to provide a visual representation of a monitored environment 712 with indicators or overlays on the representation which describe the location of the at least one monitoring device 714. Selecting these overlays using the interface 702 of the computing device 704 may provide the user with a list of options for controlling device functionality. An option may be provided for viewing device data that has been collected over a particular time period 716. The interface may also provide options to allow the user to activate or deactivate a particular device 718 or to send a test signal to a device to verify if it is functioning properly 720.

When the at least one processor of the control system analyze the at least one stored dataset and identify a change in the actions of the target species, a notification 722 can be provided through an interface 702 of the computing device 704 to indicate the identified difference. In an embodiment shown in FIG. 7B, the notification is an instructive notification 724 that indicates that at least one alterable aspect of the at least one monitoring device should be changed in response to this detected change.

The application 710 on the computing device can be configured to provide the user with easily understandable presentations of the collected data from the at least one stored dataset of the at least one monitoring device. In the exemplary embodiment provided in FIG. 7C, the number of pest entries into a particular monitoring device over various time periods is displayed in graph form 730 by the application on an interface 702 of the computing device 704. The user can also be provided with summary reports produced by the system or with notifications that prompt the user to take an action. For example, as shown in FIG. 7B, the application provided on the interface can provide a notification 724 that the user that the system has analyzed the at least one stored dataset and has identified a change in the actions of the target species in relation to the at least one monitoring device. The notification 724 instructs the user to change some alterable aspect of the at least one monitoring device. As noted previously, the alterable aspects of the at least one monitoring device include but are not limited to: a type of bait in the devices, a type of bait contained within a subset of devices, a position of bait within the devices or a location or position of the devices within the environment in which the devices are deployed. The interface of the computing device can also comprise a speaker to provide audio output as part of the notification 724. The notification 724 need not be an explicit instruction to change some alterable aspect of the at least one monitoring device. For example, the notification 724 could simply be a notification that the number of visits (entries and exits) by the target species has dropped off by more than a selected amount (e.g. by more than a selected percentage or number over a selected period of time). This can be an implicit instruction that the type of bait should be changed in order to eliminate the possibility of bait aversion.

In an embodiment, the notification provided through the interface can also indicate to the user that the required alterations to the at least one monitoring device should be performed by a certified pest control technician. For example, the notification provided may instruct the certified pest control technician to change the bait with a different type of bait, so as to verify if bait aversion has occurred by the target species. In another example, the notification provided may instruct the certified pest control technician to replace the bait with more of the same bait. This can occur, for example, if the control system has identified that more than a selected threshold number of visits have occurred to a particular monitoring device (whereupon the assumption is made that a certain amount of the bait has been consumed at each visit). Put another way, the provided notification may be indicative that more of the bait should be added to the bait storage section of at least one of the at least one monitoring device, based on how many detections of the first state have been made by the sensing circuitry.

In an embodiment, the application may prompt a user to enter in specific credentials 734 through input means of the user interface to access different levels of the control system. The input mean may be a separate keyboard or keyboard integrated within a touchscreen of the device 732. In an embodiment, there may be one set of credentials associated with a consumer of the device that allows a user to access a consumer-focused version of the application and a second set of credentials associated with an application that is for use by a certified technician. Different data and pages within the application on the computing device can be displayed or restricted according to different access levels.

Reference is made to FIG. 8, which shows a graph 800 with a first curve 802 and a second curve 804 thereon. The first curve 802 is a measure of temperature in relation to time. In the example graph, the temperature is an average weekly temperature in degrees Celsius and the time is measured in weeks. The second curve 804 is a measure of rodent activity in relation to time. The rodent activity may be given in visits to a particular monitoring device. The control system 120 may record the number of rodent visits and the temperature for each time period (e.g. for each week). Once a selected number of time periods have passed (e.g. 7 time periods) the recorded data can be analyzed, either by the control system 120 or by a person, and trends and relationships may be identified if there are any. In the example graph in FIG. 8, it can be seen that, over time periods 1-7, as the temperature drops, the number of rodent visits goes up. Additionally, it can be seen that there is a trend in the temperature curve 802 that shows that the temperature has been steadily decreasing. The short line 806 may be a graphical representation of a model for the relationship between temperature and time that the control system 120 develops using any suitable modeling algorithm after a selected time span has elapsed (in this case 7 weeks). Using this model, the control system 120 may make a prediction as to the expected temperature over the following several weeks (represented by prediction curve 808), and may then make a corresponding prediction for the number of rodents that are expected to visit the monitoring device, represented by rodent visit prediction curve segment 810). The person or organization that is responsible for providing bait to the monitoring device can then order a quantity of bait, based on the prediction. Over time, the control system 120 can also compare the real data that is subsequently recorded (e.g. data from weeks 8-11), to the predicted values that were predicted at the end of the first time span, in order to possibly refine the predictions of both the temperature (curve 808) in the time periods following that, and the expected number of rodent visits (curve 810) in the time periods following that. In relation to the method 200 described above, the monitoring device is as before provided in step 202, states are detected from the plurality of possible states as before in step 204, and at least one data set is transmitted to the control system at step 206 (which in this instance relates to the rodent visits represented in curve 804). Step 208 relates to using the control system to identify a change in the target species, which relates to noting that the number of rodent visits has increased over the initial time span (weeks 1-7). Step 210 relates to providing a notification through an interface of the control system. This can be in the form of indicating to a user that there is an expectation of increased rodent visits (and therefore bait consumption) in the future.

The control system 120 may obtain the actual temperature data in any suitable way. For example, the control system 120 may obtain the data from a weather-related website, and may pull temperature data that is in relation to the geographic region in which the monitoring device is located.

The communication between the control system 120 and the monitoring devices described herein, have been described by several different means. However, in at least some embodiments, the communication may include a cellular component. In such embodiments, the monitoring devices may each have a cellular connection to the internet, or they may all connect to a local controller via a wifi connection, and the local controller may itself connect to the internet via a cellular connection. The control system 120 may itself connect to the internet in any suitable way, e.g. via a wired connection, Wi-Fi connection, or via some other connection such as a cellular connection.

Although specific advantages have been enumerated above, various embodiments may include some, none, or all of the enumerated advantages.

Persons skilled in the art will appreciate that there are yet more alternative implementations and modifications possible, and that the above examples are only illustrations of one or more implementations. The scope, therefore, is only to be limited by the claims appended hereto and any amendments made thereto.

What is claimed is:

1. A pest control system for monitoring a target species of pest, comprising:
at least one monitoring device having a plurality of possible states which represent a plurality of actions of the target species of pest, the plurality of actions relating to at least one alterable aspect of the at least one monitoring device, the at least one monitoring device including sensing circuitry positioned to detect states from the plurality of possible states, and communication circuitry operable to transmit at least one dataset relating to the detections of the states over a wireless communication network; and
a control system including at least one processor and at least one memory, wherein the control system is configured to receive and to store the at least one dataset in the at least one memory so as to generate at least one stored dataset, wherein the at least one memory has stored therein instructions executable by the at least one processor for:
identifying a change in the actions of the target species of pest based on the at least one stored dataset; and
providing a notification through an interface of the control system, that is indicative of the change in the actions of the target species of pest.

2. The pest control system of claim 1, wherein each one of the at least one monitoring device further includes:
a bait storage section which holds a portion of bait to be ingested;
an entry aperture sized to permit an individual pest of the target species to access the bait storage section; and
a bait storage section access member that is openable to permit access to the bait storage section to add to or replace the portion of bait.

3. The pest control system of claim 1, wherein the sensing circuitry is positioned for sensing a presence of an individual pest of the target species at the pest control system, which is a first state from the plurality of possible states of the device, and for sensing a lack of presence of any of the target species, which is a second state from the plurality of possible states of the device.

4. The pest control system of claim 3, wherein the sensing circuitry includes an infrared position sensor positioned for sensing the presence of an individual pest of the target species, and for sensing the lack of presence of any of the target species.

5. The pest control system of claim 3, wherein the memory further includes instructions for identifying a difference in the actions of the target species of pest at a first one of the at least one monitoring device as compared to the actions of the target species of pest at a second one of the at least one monitoring device.

6. The pest control system of claim 1, wherein one of the at least one alterable aspect of the monitoring device includes what type of bait is held within a bait storage section of each of the at least one monitoring device.

7. The pest control system of claim 6, wherein a first state from the plurality of states corresponds to a presence of a pest of the target species within the at least one monitoring device and the stored dataset shows a reduced number of detections of the first state, over time.

8. The pest control system of claim 7, wherein the provided notification indicates that the type of bait stored within the bait storage section of at least one of the at least one monitoring device should be changed.

9. The pest control system of claim 2, wherein the portion of bait that is held within the bait storage section is a type of bait is a bait that is poisonous to the target species.

10. The pest control system of claim 2, wherein the sensing circuitry is positioned for sensing a presence of an individual pest of the target species at the pest control system, which is a first state from the plurality of possible states of the device, and wherein the provided notification indicates that the type of bait stored within the bait storage section of at least one of the at least one monitoring device should be replaced, based on how many detections of the first state have been made by the sensing circuitry.

11. The pest control system of claim 2, wherein the sensing circuitry is positioned for sensing a presence of an individual pest of the target species at the pest control system, which is a first state from the plurality of possible states of the device, and wherein the provided notification indicates that more of the bait should be added to the bait storage section of at least one of the at least one monitoring device, based on how many detections of the first state have been made by the sensing circuitry.

12. A method of monitoring a target species of pests, the method comprising:
a) providing at least one monitoring device having a plurality of possible states, which represent a plurality of actions of the target species of pest, the plurality of actions relating to at least one alterable aspect of the at least one monitoring device;
b) detecting states from the plurality of possible states on each of the at least one monitoring device;
c) transmitting at least one dataset of the detections of the states made in step b) to a control system;
d) using the control system to identify a change in the actions of the target species of pest based on the at least one stored dataset; and
e) providing a notification through an interface of the control system, that is indicative of the change in the actions of the target species of pest.

13. The method of claim 12, wherein the at least one dataset of the detections of the states is transmitted to the control system when a change in the state of at least one of the plurality of possible states is detected.

14. The method of claim 12, wherein the at least one dataset of the detections of the states is transmitted to the control system at pre-determined intervals of time.
